(19) United States
(12) Patent Application Publication
(10) Pub. No.: US 2004/0093490 A1
(43) Pub. Date: May 13, 2004

(54) Method for activating a computer system audio player with hot key

(75) Inventor: Wen-Chang Lo, Ilan (TW)

Correspondence Address: Quintero Law Office, 3rd Floor, 1617 Broadway, Santa Monica, CA, 90404, US

(73) Assignee: Mitac Technology Corp.

(21) Appl. No.: 10/384,952

(22) Filed: Mar. 10, 2003

(30) Foreign Application Priority Data
Nov. 12, 2002 (TW) 91133179

(51) Int. Cl. G06F 9/00

(52) U.S. Cl. 713/2

(57) ABSTRACT

A method for activating a computer system audio player with a hot key. The present invention discloses a method for utilizing software to implement hot key function activating an audio player located in at least one system BIOS ROM of a computer system. When using the hot key, a keystroke is generated and transmitted to a keyboard controller. A CPU activates the audio player through at least one system BIOS determining if the key was used according to the scan code based on the keystroke, finally displaying the audio player on a monitor.

### BACKGROUND OF THE INVENTION

1. Field of the Invention

The present invention relates to a method for activating a computer system audio player with hot key, detecting the scan code of the hot key through a BIOS (basic input/output system) when a computer system is powered on, and activating the audio player in accordance with the scan code.

2. Description of the Related Art

Present computer systems are attached specific keys to keyboards, like multimedia keyboards, for performing multimedia functions and special operations, such as in notebooks, desktop computers and portable computers. In addition, audio function is frequently used in a computer system, performed by an audio player implemented by software. An audio player can be a player in an operating system or controlled by a hardware controller independent of a computer system. Present computer systems implement hot key functions using an external hardware controller, such as in notebooks. It is costly to provide hot key functions by providing extra hot keys on a specially designed keyboard.

### SUMMARY OF THE INVENTION

Accordingly, an object of the present invention is to provide a method for activating an audio player by a hot key. The present invention utilizes software to implement hot key functions for a computer system, providing an audio player function in the computer system.

According to the object described above, the present invention provides a method and apparatus for activating an audio player by a hot key. The present invention discloses a method for utilizing software to implement hot key function, activating an audio player located in at least one system BIOS ROM of a computer system. The inventive architecture includes a motherboard with a CPU (central processing unit), at least one system BIOS, a keyboard controller and an I/O (input/output) port, a keyboard and a monitor.

First, an audio player located in the ROM of a BIOS is implemented. A hot key can be provided by adding a dedicated key to a specially designed keyboard or assigning at least one existing key on a standard keyboard layout. If the former methodology is employed, the hot key is capable of powering on the computer system. Using the hot key, a keystroke is generated and transmitted to the keyboard controller via the I/O port. The CPU then activates the audio player through the BIOS, recognizing the key pressed according to the scan code based on the keystroke, and initializing the audio player.

If the hot key is provided by assigning at least one existing key on a standard keyboard layout, the hot key is not capable of powering on the computer system. Using the hot key while the computer system is powering up activates the audio player.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram of a computer utilizing the inventive method of using software to implement hot key functions;

FIG. 2 is a flowchart of the method for utilizing software to implement hot key functions of the first embodiment of the present invention, in which the hot key is provided by adding a dedicated key to a specially designed keyboard;

FIG. 3 is a flowchart of the method for utilizing software to implement hot key functions of the second embodiment of the present invention, in which the hot key is provided by assigning at least one existing key on a standard keyboard layout.

### DETAILED DESCRIPTION OF THE INVENTION

The present invention provides a method of activating a computer system audio player with a hot key.

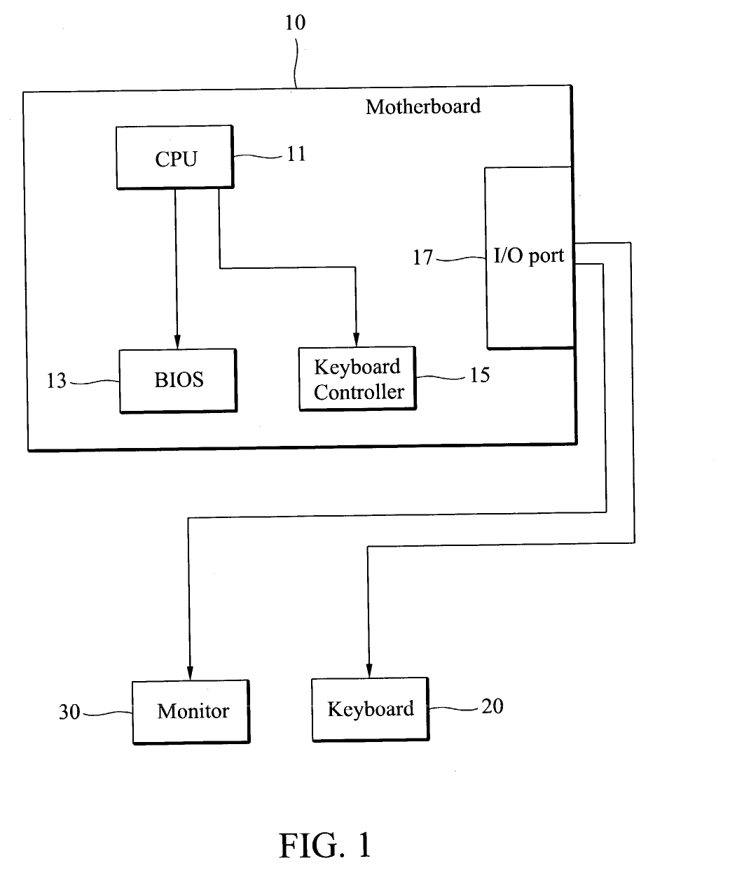

FIG. 1 is a diagram of the apparatus utilizing the inventive method of using software to implement hot key functions. The invention apparatus includes a motherboard 10, a keyboard 20 and a monitor 30. The motherboard 10 further includes a CPU 11, at least one system BIOS 13, a keyboard controller 15 and I/O port 17. An audio player located in the ROM of BIOS 13 is implemented. A keystroke is generated and transmitted to the keyboard controller 15 via the I/O port 17 when the hot key on the keyboard 20 is used. The BIOS 13 determines the key pressed according to the scan code based on the keystroke. The audio player is activated by the CPU 11 through the BIOS 13 and displayed on the monitor 30.

The hot key can be provided by adding a dedicated key independent of a power switch of a computer system to a specially designed keyboard or assigning at least one existing key on a standard keyboard layout.

### FIRST EMBODIMENT

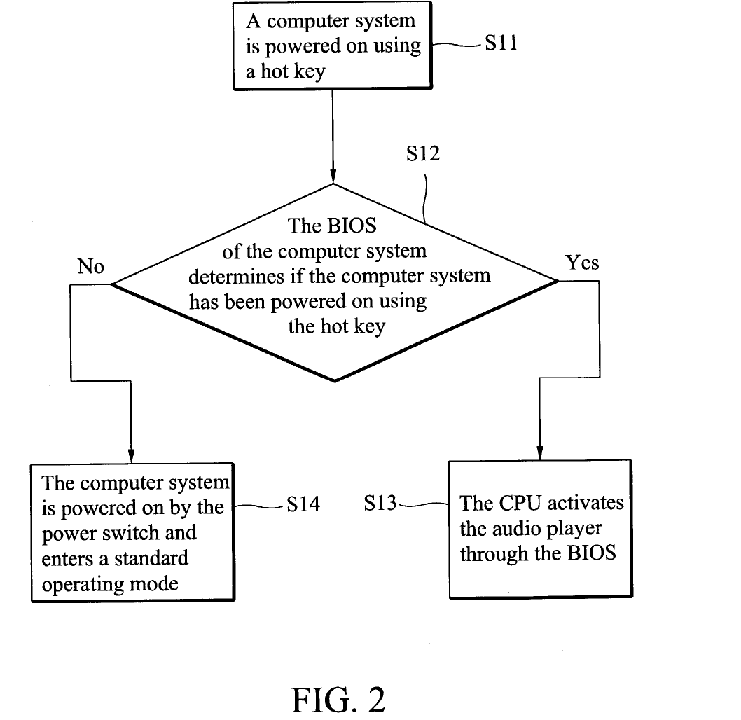

FIG. 2 is a flowchart of the method for utilizing software to implement hot key functions of the first embodiment of the present invention, in which the hot key is provided by adding a dedicated key independent of a power switch of a computer system to a specially designed keyboard, by which means the hot key is capable of powering on the computer system. The flow of the first embodiment is described in the following steps.

In S11, a computer system is powered on using a hot key.

In S12, the BIOS of the computer system determines if the computer system has been powered on using the hot key. IF so, the process goes to S13. If not, the process goes to S14.

In S13, the CPU activates the audio player through the BIOS.

In S14, the computer system is powered on by the power switch and enters a standard operating mode.

### SECOND EMBODIMENT

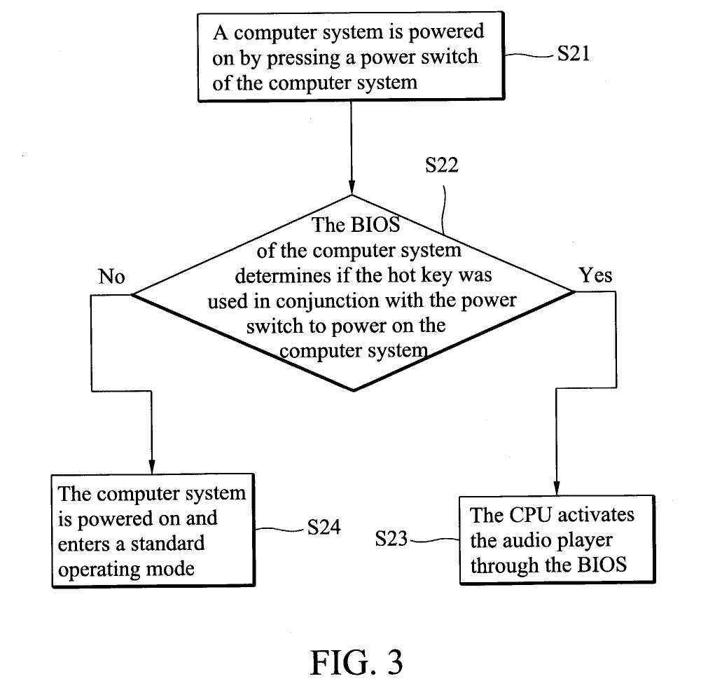

FIG. 3 is a flowchart of the method for utilizing software to implement hot key functions of the second embodiment of the present invention, in which the hot key is provided by assigning at least one existing key on a standard keyboard layout. In this embodiment, the hot key is not capable of powering on the computer system. Using the hot key while the computer system is powering on activates the audio player. The flow of the second embodiment is described in the following steps.

In S21, a computer system is powered on by pressing a power switch of the computer system. The hot key is not capable of powering on the computer system so that the computer system is powered on using the power switch.

In S22, the BIOS of the computer system determines if the hot key was used in conjunction with the power switch to power on the computer system. A scan code produced by a keystroke on the keyboard is checked by a keyboard controller to determine if the hot key has been used. If so, the process goes to S23. If not, the process goes to S24.

In S23, the CPU activates the audio player through the BIOS.

In S24, the computer system is powered on and enters a standard operating mode.

Thus, the present invention discloses a method and apparatus for utilizing software solution to implement hot key functions in a computer system, providing the same functionality as a computer system with embedded controller, thereby achieving the stated objects.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of activating an audio player by a hot key independent of a power switch of a computer system, comprising the steps of:
storing the audio player in a memory device allocated to at least one system BIOS of the computer system;
powering up the computer system to activate the BIOS;
the BIOS detecting if the computer system has been powered up using the hot key; and
the BIOS initializing the audio player if the computer system has been powered up using the hot key.

2. The method as claimed in claim 1, wherein the step of powering up the computer system is enabled by the hot key or the power switch.

3. A method of activating an audio player by a hot key independent of a power switch of a computer system, comprising the steps of:
storing the audio player in a memory device allocated to at least one system BIOS of the computer system;
powering up the computer system to activate the BIOS;
the BIOS detecting if the hot key was pressed and held when the computer system was powered up; and
the BIOS initializing the audio player if the hot key was pressed and held when the computer system was powered up.

4. The method as claimed in claim 3, wherein the hot key is disposed on a keyboard of the computer system.

5. The method as claimed in claim 4, wherein the detection step is performed by checking a scan code produced by a keystroke on the keyboard using a keyboard controller to determine if the hot key was used.

6. The method as claimed in claim 5, wherein the keyboard controller is a embedded controller.

7. A computer system, comprising:
a keyboard by a hot key;
a keyboard controller, coupled with the keyboard, for receiving a scan code corresponding to the hot key from the keyboard;
at least one system BIOS with a memory device storing an audio player; and
a CPU, coupled to the BIOS and the keyboard controller, for activating the BIOS to detect, when the computer system is powered on, if the hot key was used according to the scan code, and executing the audio player when the hot key was used.
